(19) United States
(12) Patent Application Publication
(10) Pub. No.: US 2025/0005452 A1
(43) Pub. Date: Jan. 2, 2025

(54) WEIGHT OSCILLATION MITIGATION DURING MACHINE LEARNING

(71) Applicant: QUALCOMM Incorporated, San Diego, CA (US)

(72) Inventors: Markus NAGEL, Amsterdam (NL); Marios FOURNARAKIS, London (GB); Tijmen Pieter Frederik BLANKEVOORT, Amsterdam (NL); Yelysei BONDARENKO, Amsterdam (NL)

(21) Appl. No.: 18/708,948

(22) PCT Filed: Jan. 24, 2023
(86) PCT No.: PCT/US2023/061168

§ 371 Date: May 9, 2024

(30) Foreign Application Priority Data
Jan. 27, 2022 (GR) 20220100078

(51) Int. Cl. G06N 20/00

(52) U.S. Cl. CPC G06N 20/00

(57) ABSTRACT

Certain aspects of the present disclosure provide techniques and apparatus for mitigating weight oscillation during quantization-aware training. In one example, a method includes identifying oscillation of a parameter of a machine learning model during quantization-aware training of the machine learning model, and applying an oscillation mitigation procedure during the quantization-aware training of the machine learning model in response to identifying the oscillation, the oscillation mitigation procedure comprising at least one of oscillation dampening or parameter freezing.

### CROSS-REFERENCE TO RELATED APPLICATIONS

This application claims priority to Greek Patent Application No. 20220100078, filed Jan. 27, 2022, the entire contents of which are incorporated herein by reference.

### INTRODUCTION

Aspects of the present disclosure relate to mitigating weight oscillation during quantization-aware training of machine learning models.

When training neural networks with simulated quantization, quantized weights can tend to oscillate between two quantization grid-points. These weight oscillations can lead to a significant accuracy degradation due to inaccurate estimation of the statistics (e.g., for batch-normalization) after training and/or increased noise during optimization. These effects may be particularly pronounced in low-bits (e.g., 4-bits or less) quantization, especially in efficient networks that have a relatively small number of parameters per output in a layer, such as MobileNetV2, MobileNetV3, and EfficientNet-Lite to name a few examples. Some conventional quantization-aware-training (QAT) algorithms are unable to overcome these oscillations, and thus, training may be compromised and accuracy may be reduced.

### BRIEF SUMMARY

Certain aspects of the present disclosure generally relate to mitigating the weight oscillations during quantization-aware training of machine learning models.

Certain aspects provide a method comprising: identifying oscillation of a parameter of a machine learning model during quantization-aware training of the machine learning model; and applying an oscillation mitigation procedure during the quantization-aware training of the machine learning model in response to identifying the oscillation, the oscillation mitigation procedure comprising at least one of oscillation dampening or parameter freezing.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts examples of weight oscillation during training.

FIG. 2 depicts example histograms of distances of latent weights from their closest quantization grid point.

FIG. 3 depicts an example method for applying oscillation mitigation techniques during training.

FIG. 4 depicts an example method for selectively freezing weights to mitigate oscillation.

FIG. 5 depicts an example method for mitigating weight oscillation during quantization-aware training of a machine learning model.

FIG. 6 is a block diagram illustrating a processing system which may be configured to perform aspects of the various methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for mitigating weight oscillations during quantization-aware training of machine learning models.

Quantization is an effective method for optimizing neural networks for efficient inference and on-device execution while maintaining high accuracy. By compressing weights and activations from, for example, 32-bit floating-point format to more efficient fixed-point representations, such as 8-bit integer (INT8), it is possible to reduce the memory footprint and accelerate inference, thus lowering the power consumption and silicon area when deploying neural networks on a wide array of devices, including devices with limited resources (e.g., power, computer, memory, and/or the like), such as edge processing devices, always-on devices, sensors, mobile devices, Internet of things (IoT) devices, and the like.

Due to the inherent resilience of neural networks to random perturbations, it has been shown that neural networks can be quantized to 8-bits with minimal drop in accuracy using post-training quantization techniques (PTQ). PTQ can be very efficient and, generally, only demands access to a small calibration dataset. However, PTQ suffers when applied to low-bit quantization (e.g., ≤4-bits) of neural networks. Meanwhile, quantization-aware training (QAT) includes techniques for achieving low-bit quantization of neural networks while maintaining near full-precision accuracy. By simulating the quantization operation during training and/or fine-tuning, the network can adapt to the quantization noise and thereby reach more optimal solutions (e.g., more accurate predictions) as compared to PTQ approaches.

Some aspects described herein can mitigate the oscillations of quantized weights that occur during quantization-aware training. For example, during some conventional QAT procedures, based on the use of straight-through estimators, weights oscillate (seemingly randomly) around decision thresholds, leading to detrimental noise during the optimization process. Such oscillations can create significant consequences for the network both during and after training. For example, an adverse symptom of these weight oscillations is that the oscillations can corrupt the estimated inference statistics of the batch-normalization layer collected during training, leading to poor quantized inference accuracy. This effect may be particularly pronounced in low-bit quantization of efficient networks with depth-wise separable layers, such as MobileNetV2 and MobileNetV3-Small.

One conventional approach to resolving or mitigating the oscillation-induced loss of accuracy due to incorrectly estimated batch normalization statistic is to re-estimate the batch-normalization statistics after training. However, while batch-normalization re-estimation overcomes some of the symptoms of the oscillations, these re-estimation approaches do not solve or mitigate the root of the problem itself. Aspects described in the present disclosure present several approaches for effectively reducing weight oscillations during training, including iterative freezing of oscillating weights, as well as oscillation dampening. By addressing oscillations at their source (rather than attempting to mitigate symptoms), the disclosed approaches can significantly improve accuracy beyond the level of batch-normalization re-estimation and other conventional solutions.

### Quantization-Aware Training

One technique to enable and improve quantization for a neural network is by training the network with simulated quantization in the network (e.g., using QAT, as discussed above). For example, during the forward pass, floating point weights and activations may be quantized using techniques or computation such as given in Equation 1 below, where w is any given weight vector, w is a quantized version of the weight vector w, q(·) is a quantizer that generates quantized output for input w based on inputs s, n, and p, round(·) is the round-to-nearest operator, s a scaling factor, n and p the lower and upper quantization thresholds, and clip(·) is a function for clamping w within a valid quantization range between n and p.

$$\hat{w} = q ( w ; s , n , p ) = s \cdot clip ( round ( \frac{w}{s} ) , n , p ) \qquad ( 1 )$$

In QAT approaches that use simulated quantization during training (such as using Equation 1), the quantized weights w are generally the weights that will be used for the actual quantized network when the training process is completed (e.g., for inferencing). The original weights w may be used during optimization, and are sometimes referred to as the latent weights or shadow-weights. Although the illustrated example depicts quantizing the weights, in some aspects, Equation 1 can similarly be used to quantize other values during training, such as activation data.

A fundamental challenge in the QAT formulation is that the rounding function in Equation 1 does not have a meaningful gradient, which makes gradient-based training impossible. One method for alleviating this issue is estimating the gradients with the straight-through estimator during training. Practically, this means that in the forward-pass, Equation 1 is followed, but in the backward pass, the clipping function is ignored (at least inside of the quantization grid) and the gradient of w is defined with respect to the loss [symbol] , such as using Equation 2 below, where 1 is an indicator function that operates as such: 1 is w if w falls within the quantization grid, and 0 otherwise. Thus, there is no gradient outside of the representable quantization region.

$$\frac{\partial ℒ}{\partial w} = \frac{\partial ℒ}{\partial \hat{w}} \cdot {1}_{n \leq w / s \leq p} \qquad ( 2 )$$

### Oscillations in Quantization-Aware Training

The straight-through estimator (STE) formulation in quantization has a counter-intuitive side-effect, which is that STE causes implicit stochasticity during the optimization process due to the latent weights oscillating around the decision boundary, as discussed above.

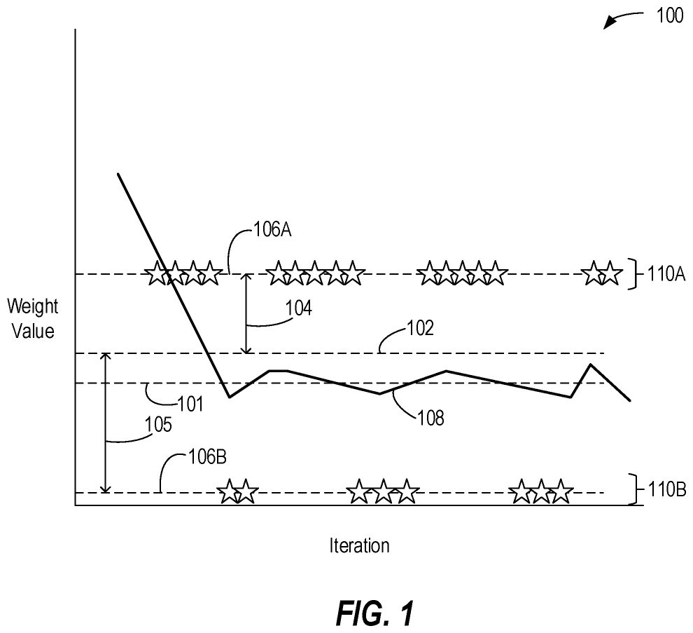

Consider a simple example in which an optimal weight w* is set as a target for a single weight w to approximate. The loss is formulated as [symbol] =(w*−q(w))² with q being the quantizer discussed above with reference to Equation 1. This quantizer gives two representable grid-points for the weights: w⁺ above the optimal weight and w-below the optimal weight, as depicted in FIG. 1 and discussed in more detail below.

FIG. 1 depicts a graph 100 where the horizontal axis corresponds to the training iteration and the vertical axis indicates the value of a specific weight at each iteration. That is, for each position on the horizontal axis (e.g., each iteration), the line 108 indicates the value of the specific latent or shadow weight reflected in the graph 100. That is, the line 108 indicates the value of the full-precision (unquantized) weight. In the illustrated example, line 101 indicates the quantization threshold, where values above the threshold, when quantized, snap to a value indicated by line 106A, and values below the threshold, when quantized, snap to a value indicated by line 106B. Additionally, in FIG. 1, line 102 is included to depict the optimal target weight w*.

As depicted in FIG. 1, when optimizing w in this example with the STE formulation, it is apparent that the latent weight w (with a value indicated by the line 108) oscillates around the decision threshold (w⁺+w⁻)/2 (indicated as the line 101), as opposed to converging to the optimal value q(w*). This is due to the fact that the gradient from Equation 1 is constant for values above the threshold, pushing the latent weight always down, as well as constant for values below the threshold, always pushing up. This oscillatory behavior means that the weight will not naturally converge to the optimal discretized value, but always exhibits randomness over the optimization iterations, jumping between w⁺ and w⁻. Notably, these oscillations happen regardless of the learning rate. Decreasing the learning rate decreases the amplitude of the oscillations themselves, but the frequency of rounding up/down stays constant. By decreasing the learning rate, the weights tend to get closer to the decision threshold. A side effect of this behavior is that the latent weights themselves are meaningless when the quantizer is removed. Thus, the resulting network performs poorly.

An important aspect of the oscillation patterns depicted in FIG. 1 is encapsulated not in the latent weight itself (which is not used for inferencing), but in the period of the latent weight's oscillation around the decision boundary (indicated by the line 101). For example, if w* (indicated by the line 102) is closer to w⁺ (e.g., closer to the upper bound of the oscillation), then the gradient is smaller above the threshold than below. In this case, it follows that the latent weight w spends more time above the decision threshold (line 101) than below. This pattern is depicted by stars 110A and 110B, which represent specific quantized weight values at a given iteration. As illustrated, because w* is closer to w⁺ than to w⁻ (the lower bound of the oscillation), when the latent weight is above the decision threshold (line 101), the quantized weights (reflected by the stars 110A) are closer to the target value (indicated by the line 102), as compared to the quantized weights (represented by the stars 110B) when the latent weight is below the threshold. That is, as illustrated, the distance between the upper quantized value (at line 106A) and the target value (at line 102), which is indicated by arrow 104, is lower than the distance between the lower quantized value (at line 106B) and the target value (at line 102), which is indicated by arrow 105.

Accordingly, the period of the oscillation around the decision boundary is directionally proportional to the closeness of w* to w⁺. This periodicity is similar to what happens in stochastic rounding, where the closeness of the latent weight to the grid-point is related to the probability of rounding to that grid-point. However, in the case of the STE, the introduced random process occurs not due to sampling at every iteration, but due to the optimization updates over subsequent iterations. In large neural networks, these random oscillations of each of the many weights in a network can lead to unstable behavior, and difficulties in optimization. Indeed, in converged networks, many of the weights lie disproportionately close to the decision boundaries.

There are two major concerns associated with the oscillations, such as depicted in the example of FIG. 1, in neural network training.

Firstly, the oscillations negatively affect the batch-normalization statistics. Due to the fact that many weights oscillate between two values, even at supposed convergence of the network, each individual instance of the network in-between gradient updates can exhibit a very different mean and variance of the outputs of each of the instance's layers. Accordingly, especially for layers with a small number of weight parameters per output, quantization can lead to a strongly detrimentally biased output compared to the floating point model. Notably, batch-normalization tracks the running mean and variance for each layer's output, so the mean and variance can be used at inference time. However, for inference time, only one such instance of the network is chosen, and this instance's mean and variance for each output in a layer are likely to be different from the running mean and variance averaged over many training iterations.

Secondly, the oscillations negatively affect training outcomes. For example, the oscillations prevent finding good local minima, which affects trained model performance.

### Mitigating Oscillations in Quantization-Aware Training

As mentioned above, the negative effects of oscillations on the batch normalization statistics can be mitigated by re-estimating the statistics as done, for example, in stochastic quantization formulations. However, this re-estimation approach does not mitigate the adversarial effect oscillations might have on the training itself, nor does the re-estimation approach mitigate the oscillations themselves. In aspects of the present disclosure, therefore, techniques are provided to prevent or mitigate such oscillations during training.

Initially, for an oscillation to occur in iteration t, two conditions are generally satisfied. First, the integer value (e.g., quantized value) of the weight should change, thus wᵢₙₜ^{t}≠wᵢₙₜ^{t-1}, where w nt is the integer value of the quantized weight at iteration t, wᵢₙₜ^{t-1} is the integer value of the quantized weight at iteration t−1, and

$${w}_{int}^{r} = clip ( round ( \frac{w}{s} ) , n , p ) .$$

As above, round (·) is the round-to-nearest operator, s a scaling factor, n and p the lower and upper quantization thresholds, and clip(·) is a function for clamping w within a valid quantization range between n and p. Second, the direction of the change (e.g., the gradient) in the integer domain should be the opposite (e.g., the opposite sign) than the direction of the previous switch in the integer domain. Thus o^{t}=sign(Δᵢₙₜ^{t})≠sign(Δᵢₙₜ^{k}), where o^{t} indicates whether the weight oscillated at iteration t, k is the iteration of the last switch in the integer domain and Δᵢₙₜ^{x}=wᵢₙₜ^{x}−ᵢₙₜ^{x-1} the direction of the change.

Given these conditions, the frequency of oscillations may be tracked over time using, for example, an exponential moving average (EMA) according to Equation 3 below, where f^{t} is the exponential moving average of the oscillation frequency, o^{t} indicates whether a weight oscillated at time t, and m is a parameter that weights “recency” of the observations for calculating the moving average.

$${f}^{t} = m \cdot {o}^{t} + ( 1 - m ) \cdot {f}^{t - 1} \qquad ( 3 )$$

### Oscillation Dampening

Given a way to track the oscillation frequency (e.g., using the exponential moving average as in Equation 3), one presently disclosed technique for mitigating weight oscillations during quantization-aware training may be referred to as oscillation dampening.

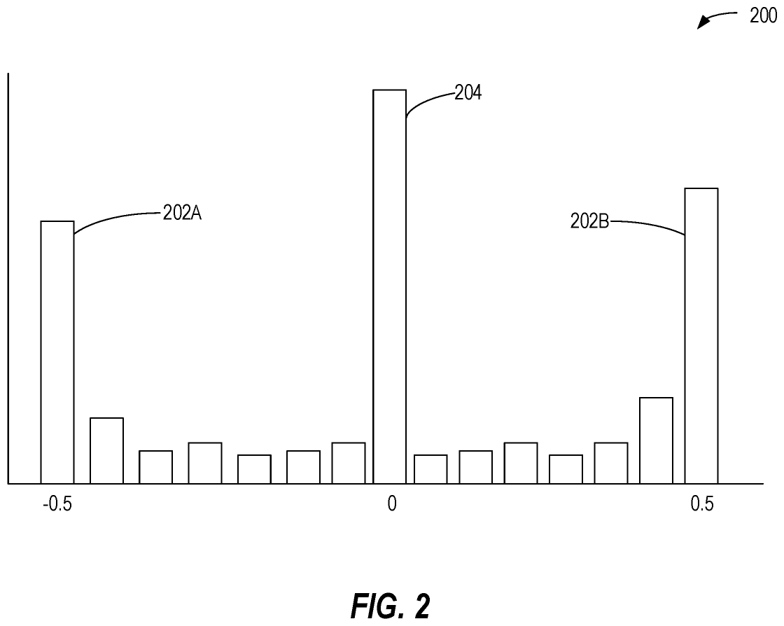

Note that when weights oscillate during quantization-aware training, the weights oscillate around the decision threshold between two quantization bins (e.g., around the line 101). This oscillation means the latent weight w is often close to the edges of a quantization bin, as depicted in the examples of FIG. 2 at bars 202A and 202B. FIG. 2 generally depicts an example histogram 200 of distances of latent weights from their closest quantization grid point. That is, the weights represented by the bars 202A and 202B are generally near the edges of the quantization bin, as compared to the weights represented by bar 204 (which are near the center of the bin, as discussed below in more detail).

In order to dampen the oscillation behavior, in some aspects, a new regularization term can be employed that encourages latent weights to be close to the center of the bin rather than its edges (e.g., nearer to the bar 204). In one aspect, a dampening loss may be defined similar to weight decay using a Frobenius norm using Equation 4 below, where [symbol] _{dampen} is the dampening loss, ŵ are the quantization bin centers (e.g., defined as s·wᵢₙₜ), and clip(w, s·n, s·p) is defined as above.

$${ℒ}_{dampen} = {‖ \hat{w} - clip ( w , s \cdot n , s \cdot p ) ‖}_{F}^{2} , \qquad ( 4 )$$

In some aspects, in Equation 4, no gradients flow through the bin center term ŵ. In an aspect, the final objective/loss for training may be defined as [symbol] = [symbol] ₜₐₛₖ+λ [symbol] _{dampen}, where [symbol] ₜₐₛₖ is the task-specific loss (e.g., cross-entropy) and λ is a hyperparameter. In some aspects, the bin regularization may be applied in the latent weight domain such that the resulting gradient is defined using Equation 5 below.

$$\frac{\partial {ℒ}_{dampen}}{\partial w} = 2 ( w - \hat{w} ) \cdot {1}_{sn \leq w \leq sp} \qquad ( 5 )$$

In one aspect, bin regularization is independent of the scale s and therefore also indirectly independent of the bit-width b. The latent weights may be further clipped to the range of the quantization grid such that only weights that do not get clipped during quantization receive the regularization effect. This clipping is useful to avoid negative interactions with learned step size quantization (LSQ)-based range learning.

### Freezing of Oscillating Weights

In some aspects, in addition to or instead of using weight dampening, a freezing approach may be used. In some aspects, the weight freezing approach may be a more targeted approach in preventing weights from oscillating. In one such aspect, the frequency of the oscillations may be tracked, per weight, during training as described above in Equation 3. If the oscillation frequency of any weight exceeds a threshold fₜₕ, then the weight may be frozen until the end of training. This freezing may be performed in the integer (e.g., quantized) domain such that potential change in the scale s would not lead to different rounding.

As discussed above, if a weight oscillates, then the weight value is not always equally frequent in each of the two quantized states. As shown in FIG. 1, the likelihood of being in one state may depend (e.g., linearly) on the distance from the quantized state and the optimal (target) value, represented by the line 102 in FIG. 1, and the expectation of overall quantized values may therefore correspond to the optimal value. If a weight oscillation exceeds the threshold and the weight is frozen, then the quantized weight could be frozen in either of the two quantized states (e.g., at a value represented by the stars 110A at the line 106A, or at a value represented by the stars 110B at the line 106B). In some aspects, in order to freeze the quantized weight to the more frequent state (which, as discussed above, may be the state closer to the optimal value), a record of the previous integer (quantized) values can be maintained using an exponential moving average (EMA) or other moving average. In one such aspect, the system can identify the more frequent integer (quantized) state to be assigned to the frozen weight by rounding the EMA. In FIG. 1, the more frequent state (at the line 106A) is the one that has more instances of a quantized weight during the training steps, which as above, is also the closer state to the optimal latent weight value (indicated by the line 102).

Note that in various aspects, both freezing and dampening can be applied to training a machine learning model.

### Example Method for Mitigating Weight Oscillation During Quantization-Aware Training

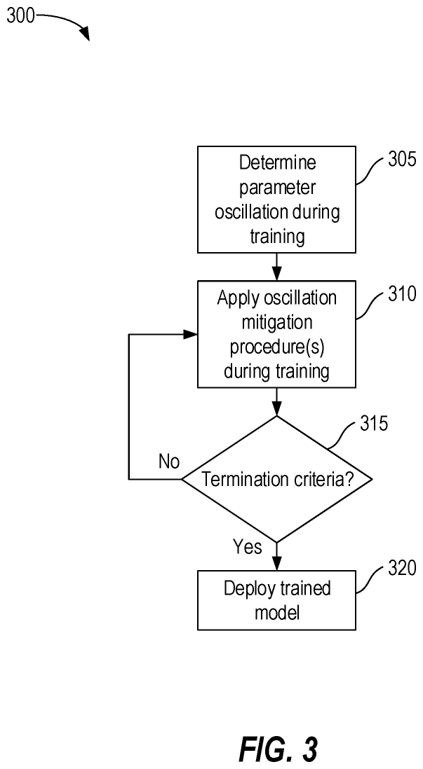

FIG. 3 depicts an example method 300 for mitigating weight oscillation during quantization-aware training of a machine learning model. In some aspects, the method 300 is performed by a training system while training a machine learning model (e.g., a neural network).

At block 305, the training system determines or identifies parameter oscillation during training. For example, in the case of a neural network, the training system may determine that one or more weights are oscillating. Generally, determining parameter oscillation can include identifying active or current oscillation of the parameter(s), as well as prediction that one or more parameters will oscillate. For example, using Equation 3 above, the training system may identify oscillation and quantify its frequency during training. Similarly, as discussed above, the training system may determine that the parameters will oscillate, such as based on prior knowledge (e.g., knowledge that weights generally oscillate during QAT).

At block 310, the training system applies one or more oscillation mitigation procedures during the training. In some aspects, as discussed above, the training comprises QAT, where weights or other parameters are quantized during training (e.g., in order to improve performance of the quantized model at inference time). Generally, the training system may use a variety of techniques to provide oscillation mitigation. For example, as discussed above, the training system may use an oscillation dampening technique (e.g., using Equation 4 above) to cause the weights to tend towards the centers of the quantization bins, rather than the edges. As discussed above, this dampening can reduce or prevent oscillation and thereby improve the training process and improve model accuracy. As another example, the training system may additionally or alternatively use a weight freezing technique to freeze any parameters that are oscillating above a threshold. This freezing can similarly improve the training process and further improve model accuracy.

At block 315, the training system determines whether one or more training termination criteria are met. Generally, these termination criteria can include a wide variety of considerations, such as reaching a defined maximum time, number of iterations, and/or computational resources spent training the model, a desired model accuracy (e.g., determined using test data), whether more training data remains, and the like.

If the training system determines that the termination criteria are not satisfied, the method 300 returns to block 310 to continue training using the oscillation dampening technique(s) (e.g., to begin a new iteration). If, at block 315, the training system determines that one or more termination criteria are met, then the method 300 continues to block 320, where the training system deploys the trained model. As discussed above, because the model was trained using oscillation dampening techniques, the model is generally more accurate and reliable than some conventional QAT approaches. In some aspects, as discussed above, the model is quantized for inference time. That is, the model uses quantized weights or other parameters, significantly reducing the computational expense of using the trained model. Generally, deploying the model can include a variety of operations, including deploying the model locally for inference, providing the model to one or more other systems, and the like.

### Example Method for Weight Freezing During Quantization-Aware Training

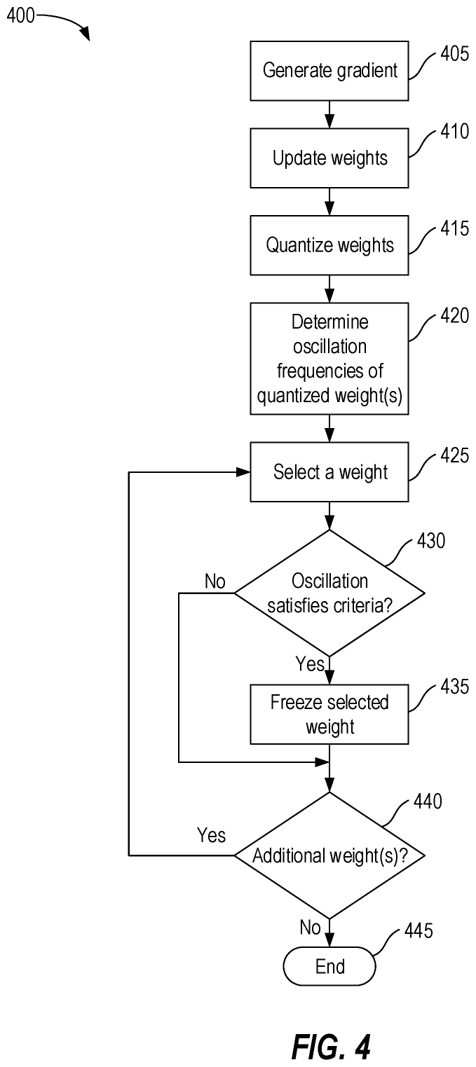

FIG. 4 depicts an example method 400 for mitigating weight oscillation during quantization-aware training of a machine learning model. In some aspects, the method 400 provides additional detail for block 310 of FIG. 3. In some aspects, the method 400 is performed by a training system while training a machine learning model (e.g., a neural network).

In some aspects, the method 400 corresponds to a single iteration or time step while training a model. At block 405, the training system generates one or more gradients during the iteration. In some aspects, as discussed above, the gradient may be defined using Equation 5 above, and/or defined as

$${g}^{t} = \frac{\partial ℒ}{\partial w} ,$$

where [symbol] is the loss (which may include dampening loss, as discussed above) and w is the weights.

At block 410, the training system uses an optimizer to determine and/or apply weight updates to the weights (and/or other parameters, such as biases) of the model based on the generated gradient.

At block 415, the training system then quantizes the updated weights, as discussed above. For example, the training system may use Equation 1 above to quantize the weights, and/or may generate quantized weights wᵢₙₜ^{t} at iteration t as

$$clip ( ⌊ \frac{{w}^{t}}{s} ⌋ , n , p ) .$$

At block 420, the training system can determine or identify oscillation frequencies of one or more quantized weights. For example, as discussed above, the training system may use Equation 3 to quantify the oscillation frequency of each parameter.

At block 425, the training system selects one of the quantized weights (or other parameters) for evaluation. Generally, the training system may select the quantized weight using any suitable technique, including randomly or pseudo-randomly, as all such parameters may be evaluated during the method 400. Though an iterative process (e.g., selecting each parameter in turn) is depicted for conceptual clarity, in some aspects, the training system may select and evaluate multiple parameters in parallel. Additionally, in some aspects, the training system may select a weight from the set of non-frozen weights. That is, if any weights have already been frozen during a prior training iteration (e.g., due to oscillation), the training system may leave these frozen weights unchanged, and review any non-frozen weights to determine whether they should now be frozen.

At block 430, the training system determines whether oscillation of the selected (quantized) weight, if present, satisfies one or more oscillation criteria. For example, the training system may compare any detected oscillation against a defined oscillation frequency threshold to determine whether the weight is oscillating with sufficient frequency. If not, then the method 400 proceeds to block 440.

If the training system determines that the oscillation of the selected weight satisfies the criteria (e.g., the oscillation frequency is sufficiently high), the method 400 continues to block 435. At block 435, the training system freezes the selected (quantized) weight for the remainder of training. In some aspects, as discussed above, the training system can determine or identify the value at which to freeze the weight based on the weight's historical statistics. For example, if the quantized weight oscillates between two values or states, then the training system may determine which state or value is the most common for the weight (e.g., present for the largest number of iterations). This most-common state or value can then be used as the frozen value for the quantized weight (e.g., because the quantized weight is likely to be closer to the center of the true optimal value). The method 400 then continues to block 440.

At block 440, the training system determines whether there is at least one additional weight or other parameter that remains to be evaluated. If so, then the method 400 returns to block 425. If not, then the method 400 terminates at block 445. In some aspects, if the method 400 corresponds to block 310 of FIG. 3, the training system can then proceed to block 315 to determine whether to initiate another iteration of the training. During the next iteration (if any), the training system may again use the method 400 to determine whether any weights should be frozen. In some aspects, as discussed above, the training system may leave any previously frozen weights (e.g., frozen during a prior iteration) frozen/unchanged, and may evaluate any non-frozen elements in the current iteration to determine whether they should be frozen.

In this way, the training system can provide oscillation mitigation and dynamic weight freezing to substantially improve the training process and improve model accuracy and performance.

### Example Method for Mitigating Weight Oscillation During Quantization-Aware Training

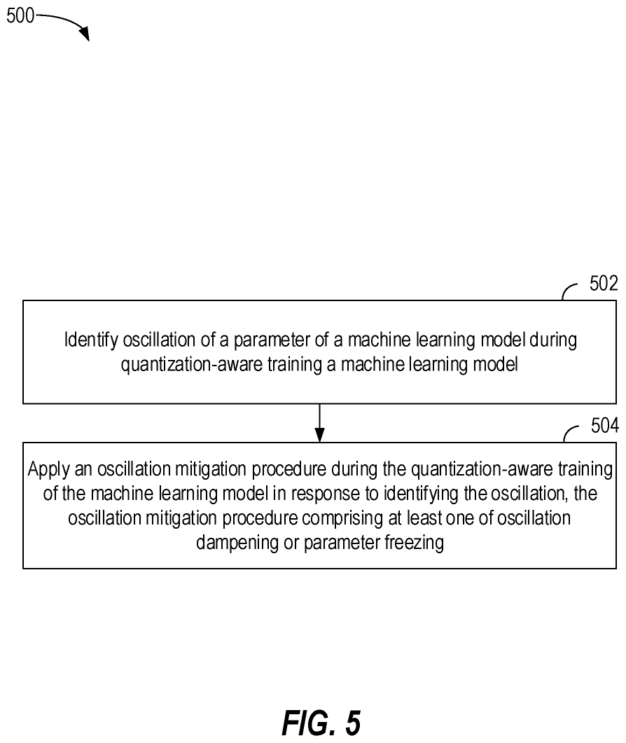

FIG. 5 depicts an example method 500 for mitigating weight oscillation during quantization-aware training of a machine learning model.

At block 502, oscillation of a parameter of a machine learning model during quantization-aware training of the machine learning model is identified. In some aspects, the operations of block 502 correspond to one or more operations described above with reference to block 305 of FIG. 3.

At block 504, an oscillation mitigation procedure is applied during the quantization-aware training of the machine learning model in response to identifying the oscillation, the oscillation mitigation procedure comprising at least one of oscillation dampening or parameter freezing. In some aspects, the operations of block 504 correspond to one or more operations described above with reference to block 310 of FIG. 3.

In some aspects, the parameter of the machine learning model comprises a quantized weight of the machine learning model.

In some aspects, identifying the oscillation comprises determining an integer weight value oscillation frequency associated with the quantized weight of the machine learning model.

In some aspects, determining the integer weight value oscillation frequency associated with the quantized weight of the machine learning model includes: detecting a first change in an integer value of the quantized weight, detecting a second change in the integer value of the quantized weight, wherein a gradient of the second change has an opposite sign as a gradient of the first change, and estimating the integer weight value oscillation frequency associated with the quantized weight based on an exponential moving average of one or more changes in the integer value of the quantized weight, including the first change and the second change.

In some aspects, the oscillation mitigation procedure comprises freezing the integer value of the quantized weight at a set value for any remaining iterations during the quantization-aware training of the machine learning model.

In some aspects, the method 500 further includes applying a second oscillation mitigation procedure during the quantization-aware training of the machine learning model, wherein the second oscillation mitigation procedure comprises updating the machine learning model based on a loss function including an oscillation dampening loss regularization term.

In some aspects, the method 500 further includes applying the oscillation mitigation procedure based on the integer weight value oscillation frequency exceeding an oscillation frequency threshold.

In some aspects, the method 500 further includes determining the set value based on a rounded exponential moving average value of the quantized weight.

In some aspects, the oscillation mitigation procedure comprises updating the machine learning model based on a loss function including an oscillation dampening loss regularization term.

In some aspects, the loss function is [symbol] = [symbol] ₜₐₛₖ+λ [symbol] _{dampen}, where [symbol] ₜₐₛₖ is a task loss value, [symbol] _{dampen} is the oscillation dampening loss regularization term, and λ is a hyperparameter.

In some aspects, the oscillation dampening loss regularization term is [symbol] _{dampen}=∥ŵ−clip(w, s·n, s·p)∥_{F}², where ŵ is a center of a valid quantization range, and clip(·) is a function for clamping w within the valid quantization range between n and p.

In some aspects, updating the machine learning model based on the loss function including the oscillation dampening loss regularization term comprises determining a gradient of the oscillation dampening loss regularization term L_{dampen} according to

$$\frac{\partial {ℒ}_{dampen}}{\partial w} = 2 ( w - \hat{w} ) \cdot {1}_{sn \leq w \leq sp} ,$$

where w is a weight value of the machine learning model, and ŵ is a center of a valid quantization range.

### Example Processing System for Performing Oscillation Mitigation During Quantization-Aware Training

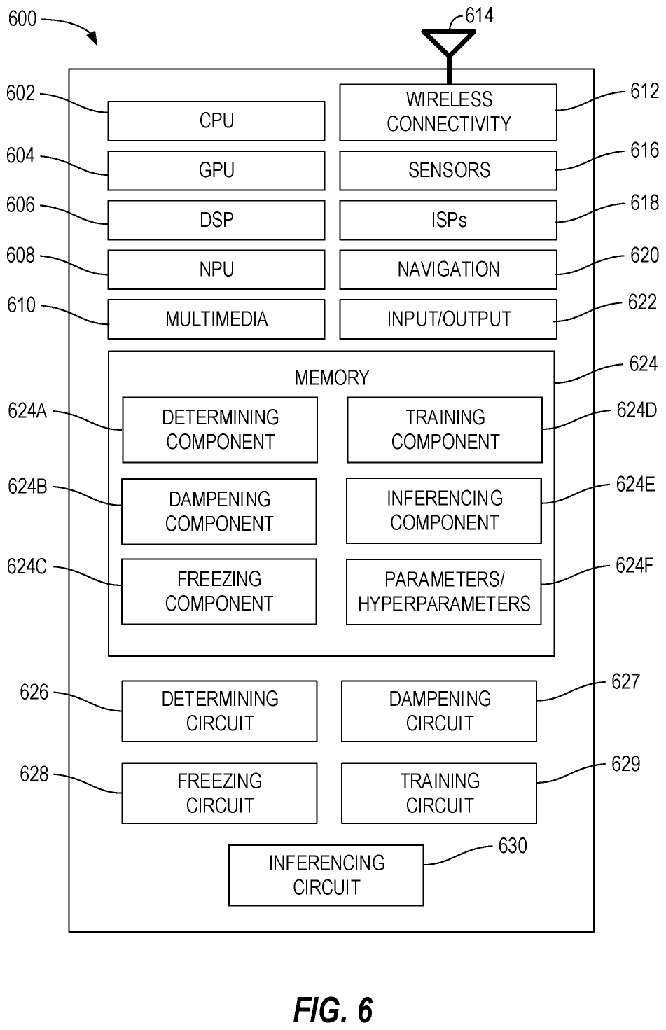

In some aspects, the workflows, architectures, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In one aspect, the processing system 600 may train, implement, or provide oscillation mitigation during training of machine learning models (e.g., using QAT), as described above. Although depicted as a single system for conceptual clarity, in at least some aspects, as discussed above, the operations described below with respect to the processing system 600 may be distributed across any number of devices.

Processing system 600 includes a central processing unit (CPU) 602, which in some examples may be a multi-core CPU. Instructions executed at the CPU 602 may be loaded, for example, from a program memory associated with the CPU 602 or may be loaded from a partition of memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 612 is further coupled to one or more antennas 614.

Processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes a determining component 624A, a dampening component 624B, a freezing component 624C, a training component 624D, and an inferencing component 624E. Though depicted as discrete components for conceptual clarity in FIG. 6, the illustrated components (and others not depicted) may be collectively or individually implemented in various aspects. Additionally, though depicted as residing on the same processing system 600, in some aspects, training and inferencing may be performed on separate systems.

In the illustrated example, the memory 624 further includes model parameters/hyperparameters 624F. The model parameters/hyperparameters 624F may generally correspond to the learnable or trainable parameters of one or more machine learning models (e.g., latent or shadow weights), quantized parameters of the model(s), and/or hyperparameters of the model(s). Though depicted as residing in memory 624 for conceptual clarity, in some aspects, some or all of the model parameters/hyperparameters 624F may reside in any other suitable location.

Processing system 600 further comprises determining circuit 626, dampening circuit 627, freezing circuit 628, training circuit 629, and inferencing circuit 630. The depicted circuits, and others not depicted, may be configured to perform various aspects of the techniques described herein.

In an aspect, determining component 624A and/or determining circuit 626 may generally be used to determine or identify parameter oscillation, and/or to determine the frequency of such oscillation, as discussed above. Dampening component 624B and/or dampening circuit 627 may generally be used to provide weight dampening (e.g., using Equation 4 above) in order to mitigate or prevent parameter oscillation, as discussed above. Similarly, freezing component 624C and/or freezing circuit 628 may be used to selectively freeze quantized weights to prevent further oscillation, as discussed above.

The training component 624D and/or training circuit 629 may be used to train or learn one or more parameters (e.g., parameters of the parameters/hyperparameters 624F), as discussed above. Inferencing component 624E and/or inferencing circuit 630 may generally be used to generate inferences or predictions based on one or more learned parameters, as discussed above. In some aspects, as discussed above, the inferencing component 624E and/or inferencing circuit 630 may use quantized machine learning models to generate the predictions efficiently.

Though depicted as separate components and circuits for clarity in FIG. 6, determining circuit 626, dampening circuit 627, freezing circuit 628, training circuit 629, and inferencing circuit 630 may collectively or individually be implemented in other processing devices of processing system 600, such as within CPU 602, GPU 604, DSP 606, NPU 608, and the like.

Generally, processing system 600 and/or components thereof may be configured to perform the methods described herein.

Notably, in other aspects, aspects of processing system 600 may be omitted, such as where processing system 600 is a server computer or the like. For example, multimedia processing unit 610, wireless connectivity component 612, sensor processing units 616, ISPs 618, and/or navigation component 620 may be omitted in other aspects. Further, aspects of processing system 600 may be distributed between multiple devices.

### Example Clauses

Implementation examples are described in the following numbered clauses:

Clause 1: A computer-implemented method of machine learning, comprising: identifying oscillation of a parameter of a machine learning model during quantization-aware training of the machine learning model; and applying an oscillation mitigation procedure during the quantization-aware training of the machine learning model in response to identifying the oscillation, the oscillation mitigation procedure comprising at least one of oscillation dampening or parameter freezing.

Clause 2: The method of Clause 1, wherein the parameter of the machine learning model comprises a quantized weight of the machine learning model.

Clause 3: The method of Clause 2, wherein identifying the oscillation comprises determining an integer weight value oscillation frequency associated with the quantized weight of the machine learning model.

Clause 4: The method of Clause 3, wherein determining the integer weight value oscillation frequency associated with the quantized weight of the machine learning model includes: detecting a first change in an integer value of the quantized weight; detecting a second change in the integer value of the quantized weight, wherein a gradient of the second change has an opposite sign as a gradient of the first change; and estimating the integer weight value oscillation frequency associated with the quantized weight based on an exponential moving average of one or more changes in the integer value of the quantized weight, including the first change and the second change.

Clause 5: The method of Clause 3 or 4, wherein the oscillation mitigation procedure comprises freezing the integer value of the quantized weight at a set value for any remaining iterations during the quantization-aware training of the machine learning model.

Clause 6: The method of Clause 5, further comprising: applying a second oscillation mitigation procedure during the quantization-aware training of the machine learning model, wherein the second oscillation mitigation procedure comprises updating the machine learning model based on a loss function including an oscillation dampening loss regularization term.

Clause 7: The method of Clause 5 or 6, further comprising applying the oscillation mitigation procedure based on the integer weight value oscillation frequency exceeding an oscillation frequency threshold.

Clause 8: The method of any of Clauses 5-7, further comprising determining the set value based on a rounded exponential moving average value of the quantized weight.

Clause 9: The method of Clause 3, wherein the oscillation mitigation procedure comprises updating the machine learning model based on a loss function including an oscillation dampening loss regularization term.

Clause 10: The method of Clause 9, wherein: the loss function is [symbol] = [symbol] ₜₐₛₖ+λ [symbol] _{dampen}, [symbol] ₜₐₛₖ is a task loss value, [symbol] _{dampen} is the oscillation dampening loss regularization term, and λ is a hyperparameter.

Clause 11: The method of Clause 9 or 10, wherein: the oscillation dampening loss regularization term is [symbol] _{dampen}=∥ŵ−clip(w, s·n, s·p)∥_{F}², ŵ is a center of a valid quantization range, w is the parameter, clip(·) is a function for clamping W within the valid quantization range between n and p, s is a scaling factor, and n and p are hyperparameters.

Clause 12: The method of any of Clauses 9-11, wherein: updating the machine learning model based on the loss function including the oscillation dampening loss regularization term comprises determining a gradient of the oscillation dampening loss regularization term L_{dampen} according to

$$\frac{\partial {ℒ}_{dampen}}{\partial w} = 2 ( w - \hat{w} ) \cdot {1}_{sn \leq w \leq sp} ,$$

is a weight value of the machine learning model, and ŵ is a center of a valid quantization range.

Clause 13: A processing system, comprising: a memory comprising computer-executable instructions; and one or more processors configured to execute the computer-executable instructions and cause the processing system to perform a method in accordance with any of Clauses 1-12.

Clause 14: A processing system, comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method performed by a training system while training a machine learning model, comprising:
identifying oscillation of a parameter of the machine learning model during quantization-aware training of the machine learning model; and
applying an oscillation mitigation procedure during the quantization-aware training of the machine learning model in response to identifying the oscillation, the oscillation mitigation procedure comprising at least one of oscillation dampening or parameter freezing.

2. The method of claim 1, wherein the parameter of the machine learning model comprises a quantized weight of the machine learning model.

3. The method of claim 2, wherein identifying the oscillation comprises determining an integer weight value oscillation frequency associated with the quantized weight of the machine learning model.

4. The method of claim 3, wherein determining the integer weight value oscillation frequency associated with the quantized weight of the machine learning model includes:
detecting a first change in an integer value of the quantized weight;
detecting a second change in the integer value of the quantized weight, wherein a gradient of the second change has an opposite sign as a gradient of the first change; and
estimating the integer weight value oscillation frequency associated with the quantized weight based on an exponential moving average of one or more changes in the integer value of the quantized weight, including the first change and the second change.

5. The method of claim 3, wherein the oscillation mitigation procedure comprises freezing the integer value of the quantized weight at a set value for any remaining iterations during the quantization-aware training of the machine learning model.

6. The method of claim 5, further comprising applying a second oscillation mitigation procedure during the quantization-aware training of the machine learning model, wherein the second oscillation mitigation procedure comprises updating the machine learning model based on a loss function including an oscillation dampening loss regularization term.

7. The method of claim 5, further comprising applying the oscillation mitigation procedure based on the integer weight value oscillation frequency exceeding an oscillation frequency threshold.

8. The method of claim 5, further comprising determining the set value based on a rounded exponential moving average value of the quantized weight.

9. The method of claim 3, wherein the oscillation mitigation procedure comprises updating the machine learning model based on a loss function including an oscillation dampening loss regularization term.

10. The method of claim 9, wherein:
the loss function is [symbol] = [symbol] ₜₐₛₖ+λ [symbol] _{dampen}, [symbol]
ₜₐₛₖ is a task loss value, [symbol]
_{dampen} is the oscillation dampening loss regularization term, and
λ is a hyperparameter.

11. The method of claim 9, wherein:
the oscillation dampening loss regularization term is [symbol] _{dampen}=∥ŵ−clip(w, s·n, s·p)∥_{F}²,
ŵ is a center of a valid quantization range,
w is the parameter,
clip(·) is a function for clamping w within the valid quantization range between n and p,
s is a scaling factor, and
n and p are hyperparameters.

12. The method of claim 9, wherein:
updating the machine learning model based on the loss function including the oscillation dampening loss regularization term comprises determining a gradient of the oscillation dampening loss regularization term L_{dampen} according to
$$\frac{\partial {ℒ}_{dampen}}{\partial w} = 2 ( w - \hat{w} ) \cdot {1}_{sn \leq w \leq sp} ,$$
w is a weight value of the machine learning model, and
ŵ is a center of a valid quantization range.

13. A processing system, comprising:
a memory comprising computer-executable instructions; and
a processor configured to execute the computer-executable instructions and cause the processing system to perform an operation comprising:
identifying oscillation of a parameter of a machine learning model during quantization-aware training of the machine learning model; and
applying an oscillation mitigation procedure during the quantization-aware training of the machine learning model in response to identifying the oscillation, the oscillation mitigation procedure comprising at least one of oscillation dampening or parameter freezing.

14. The processing system of claim 13, wherein the parameter of the machine learning model comprises a quantized weight of the machine learning model.

15. The processing system of claim 14, wherein identifying the oscillation comprises determining an integer weight value oscillation frequency associated with the quantized weight of the machine learning model.

16. The processing system of claim 15, wherein determining the integer weight value oscillation frequency associated with the quantized weight of the machine learning model includes:
detecting a first change in an integer value of the quantized weight;
detecting a second change in the integer value of the quantized weight, wherein a gradient of the second change has an opposite sign as a gradient of the first change; and
estimating the integer weight value oscillation frequency associated with the quantized weight based on an exponential moving average of one or more changes in the integer value of the quantized weight, including the first change and the second change.

17. The processing system of claim 15, wherein the oscillation mitigation procedure comprises freezing the integer value of the quantized weight at a set value for any remaining iterations during the quantization-aware training of the machine learning model.

18. The processing system of claim 17, the operation further comprising applying a second oscillation mitigation procedure during the quantization-aware training of the machine learning model, wherein the second oscillation mitigation procedure comprises updating the machine learning model based on a loss function including an oscillation dampening loss regularization term.

19. The processing system of claim 17, the operation further comprising applying the oscillation mitigation procedure based on the integer weight value oscillation frequency exceeding an oscillation frequency threshold.

20. The processing system of claim 17, the operation further comprising determining the set value based on a rounded exponential moving average value of the quantized weight.

21. The processing system of claim 15, wherein the oscillation mitigation procedure comprises updating the machine learning model based on a loss function including an oscillation dampening loss regularization term.

22. A non-transitory computer-readable medium comprising computer-executable instructions that, when executed by a processor of a processing system, cause the processing system to perform an operation comprising:
identifying oscillation of a parameter of a machine learning model during quantization-aware training of the machine learning model; and
applying an oscillation mitigation procedure during the quantization-aware training of the machine learning model in response to identifying the oscillation, the oscillation mitigation procedure comprising at least one of oscillation dampening or parameter freezing.

23. The non-transitory computer-readable medium of claim 22, wherein the parameter of the machine learning model comprises a quantized weight of the machine learning model.

24. The non-transitory computer-readable medium of claim 23, wherein identifying the oscillation comprises determining an integer weight value oscillation frequency associated with the quantized weight of the machine learning model.

25. The non-transitory computer-readable medium of claim 24, wherein determining the integer weight value oscillation frequency associated with the quantized weight of the machine learning model includes:
detecting a first change in an integer value of the quantized weight;
detecting a second change in the integer value of the quantized weight, wherein a gradient of the second change has an opposite sign as a gradient of the first change; and
estimating the integer weight value oscillation frequency associated with the quantized weight based on an exponential moving average of one or more changes in the integer value of the quantized weight, including the first change and the second change.

26. The non-transitory computer-readable medium of claim 24, wherein the oscillation mitigation procedure comprises freezing the integer value of the quantized weight at a set value for any remaining iterations during the quantization-aware training of the machine learning model.

27. The non-transitory computer-readable medium of claim 26, the operation further comprising applying a second oscillation mitigation procedure during the quantization-aware training of the machine learning model, wherein the second oscillation mitigation procedure comprises updating the machine learning model based on a loss function including an oscillation dampening loss regularization term.

28. The non-transitory computer-readable medium of claim 26, the operation further comprising applying the oscillation mitigation procedure based on the integer weight value oscillation frequency exceeding an oscillation frequency threshold.

29. The non-transitory computer-readable medium of claim 26, the operation further comprising determining the set value based on a rounded exponential moving average value of the quantized weight.

30. A processing system, comprising:
means for identifying oscillation of a parameter of a machine learning model during quantization-aware training of the machine learning model; and
means for applying an oscillation mitigation procedure during the quantization-aware training of the machine learning model in response to identifying the oscillation, the oscillation mitigation procedure comprising at least one of oscillation dampening or parameter freezing.
